(19) United States
(12) Patent Application Publication
(10) Pub. No.: US 2007/0013774 A1
(43) Pub. Date: Jan. 18, 2007

(54) Display apparatus and information processing system

(75) Inventors: Ho-Suk Maeng, Seoul (KR); Kook-Chul Moon, Yongin-si (KR); Ung-Sik Kim, Suwon-si (KR); Pil-Mo Choi, Seoul (KR); Tae-Hyeong Park, Yongin-si (KR); Seock-Cheon Song, Suwon-si (KR); Sang-Hoon Lee, Seoul (KR); Keun-Woo Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/486,814

(22) Filed: Jul. 13, 2006

(30) Foreign Application Priority Data
Jul. 13, 2005 (KR) 2005-63398

(51) Int. Cl. H04N 7/18

(52) U.S. Cl. 348/87

(57) ABSTRACT

A display apparatus is implemented using an SOG or SOP technology that can integrate a plurality of circuit elements on a single substrate. The display apparatus does not include a separate frame memory. Instead of the separate frame memory, the display apparatus uses a predetermined region of a memory provided in a host by allocating it as a frame memory region. Since an image signal transmitted/received between the display apparatus and the host has a coded format, a chip size of the display apparatus and an information processing system with the same is reduced and an amount of transmission data is also reduced.

### REFERENCE TO RELATED APPLICATION

This application claims priority by virtue of application number 2005-63398 filed in the Korean Patent Office on Jul. 13, 2005

### FIELD OF THE INVENTION

The present invention relates to a display apparatus, and more particularly, to a display apparatus having a plurality of circuits integrated on the same circuit board, and an information processing system with the same.

### DESCRIPTION OF THE RELATED ART

With the development of the information society, the various demands for display apparatus are increasing. To meet the various demands, there have been developed various kinds of flat panel display devices, including liquid crystal (LCD), plasma display panel (PDP), electro luminescent display (ELD), and vacuum fluorescent display (VFD). Among them, the LCD has excellent image quality, lightweight, slim profile, and low power consumption, and thus is widely used for mobile devices. With the advent of the high-tech digital information communication age, there is a demand for new technology to implement light, slim and integrated information processing systems. System on glass (SOG) or system on plastic (SOP) technology allows all parts including of a display device to be integrated on one substrate including various kinds of function elements and circuits, including audio, display, information processing, storage, input/output, and communication circuits. Since a silicon semiconductor technology currently used must implement circuits on an expensive opaque silicon wafer, it is difficult to apply to large area electronics devices. On the contrary, the SOG (or SOP) technology can directly implement semiconductor circuits and systems on a variety of inexpensive substrate, such as a glass (or a transparent plastic). Therefore, the SOG (or SOP) technology is suitable for large area electronics devices, and can provide light, slim and simplified device, transparency, substrate's flexibility, low price, and so on.

A representative example employing the SOG technology is a thin film transistor liquid crystal display (hereinafter, referred to as a TFT-LCD). In the case of an SOG TFT-LCD, a liquid crystal panel and driving circuits (e.g., a gate driving unit, a source driving unit, etc.) are all formed on a glass substrate. Basically, the TFT-LCD requires a frame memory that can store at least one or more frame data. The frame memory is generally provided in a source driving unit. If the frame memory is integrated on a glass substrate together with the source driving unit, the size of the substrate increases. Specifically, as the resolution of the display apparatus increases, the capacity required of the frame memory also increases. Therefore, there is a demand for new approaches that can reduce the required memory capacity and manage a memory more efficiently.

### SUMMARY OF THE INVENTION

The display apparatus according to the present invention is implemented based on an SOG or SOP technology, in which a plurality of circuit components are integrated on one substrate which includes the display apparatus and a host having an image processing unit, a memory and an interface to a coding and timing control unit. Because of the memory space saved by encoding the image signal information, a separate frame memory is not required and the entire chip size in the display apparatus and the image processing system as well as the amount of data transmission is reduced.

### BRIEF DESCRIPTION OF THE DRAWINGS

The foregoing and other objects and features of the present invention may be better understood from a reading of the ensuing specification together with the drawing, in which:

FIG. 1 is a perspective view of an information processing system according to a preferred embodiment of the present invention;

FIG. 2 is a block diagram of the display apparatus and the information processing system illustrated in FIG. 1;

FIG. 3 is a flowchart illustrating a driving method of a display apparatus illustrated in FIG. 2;

FIG. 4 is a block diagram of an information processing system according to another embodiment of the present invention; and

FIG. 5 is a flowchart illustrating a driving method of a display apparatus illustrated in FIG. 4.

### DETAILED DESCRIPTION

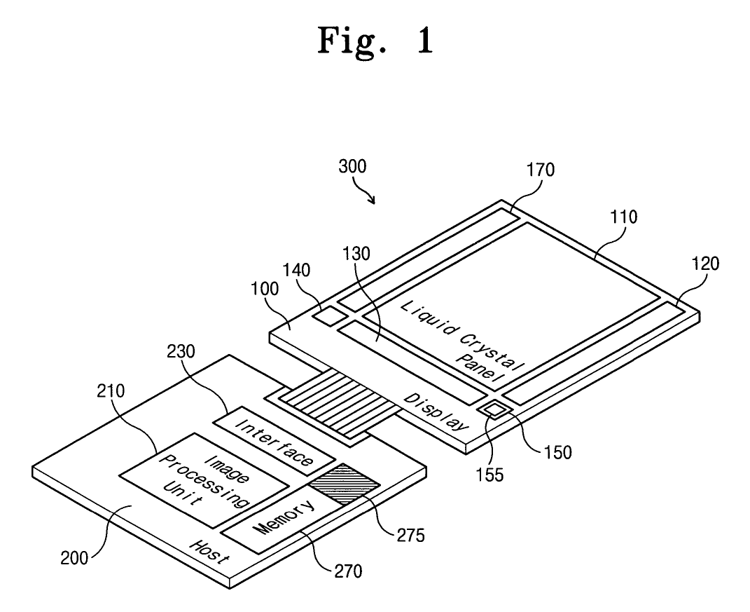

FIG. 1 is a perspective view of an information processing system 300 according to a preferred embodiment of the present invention.

Referring to FIG. 1, the information processing system 300 includes a display apparatus 100 and a host 200. Display apparatus 100 is configured using an SOG or SOP technology. According to the SOG technology, a liquid crystal panel 110 and a plurality of driving circuits can be all formed on a substrate equal to liquid crystal panel 110, that is, on the same glass substrate. The plurality of driving circuits include a gate driving unit 120, a source driving unit 130, a level shifter 140, a timing control unit 150, and a power supply 170. In FIG. 1, there is shown an LCD that is most widely used as a display apparatus of a mobile device.

Display apparatus 100 does not include a separate frame memory, but uses a predetermined region of a memory 270 provided in host 200 by allocating it as a frame memory region 275. Image data stored in the frame memory region 275 has a coded data format. Accordingly, the chip size of display apparatus 100 is reduced and therefore the chip size required for the information processing system 300 is reduced. In addition, since the image data transmitted/received between display apparatus 100 and host 200 has a coded format, the amount of transmitted data is also reduced. Host 200 actually carries out an information processing function and an image processing function intended to be performed in the information processing system 300. The processing result of host 200 (specifically, an image processing result) is displayed through display apparatus 100. Although it will be described below in detail, the processing result of host 200 is not directly displayed through display apparatus 100, but it is stored in the frame memory region 275 in a coded format and then is displayed. The reason for this is that since the display frequency of the processing result is lower than that required in an actual display apparatus, a frame memory (or a memory corresponding to the frame memory) is needed. The frame memory region 275 serves as a frame memory of display apparatus 100. Regardless of the kind of memory, any memory provided in host 200 can be allocated as the frame memory region 275.

Although the LCD has been described as an example of display apparatus 100, it is merely exemplary. For example, the present invention can also be applied to various kinds of flat panel display devices using a driving method similar to (or the same as) an LCD such as an active matrix organic light emitting diode (AMOLED). In addition, the present invention can be applied to a wearable display apparatus such as a head mounted display (HMD), a personal digital assistant (PDA) phone capable of data transmission and display, a digital still camera (DSC), a fingerprint reader, a car navigation system (CNS), an e-book, an e-paper, and so on.

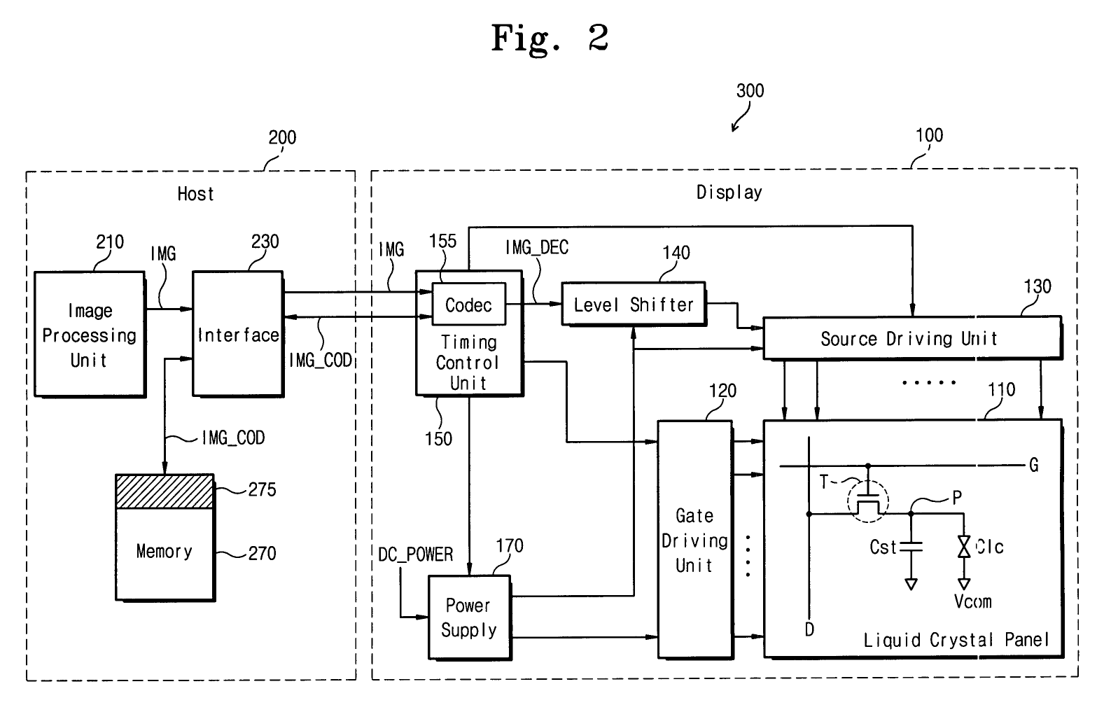

FIG. 2 is a block diagram of the SOG display apparatus 100 and the information processing system 300 illustrated in FIG. 1.

Referring to FIG. 2, host 200 includes an image processing unit 210, an interface 230, and a memory 270. Image processing unit 210 generates an image signal IMG to be displayed on display apparatus 100. An image processing algorithm performed by image processing unit 210 can be different according to characteristics of the information processing system 300. The interface 230 transmits/receives image signals IMG and IMG_COD and control signals between host 200 and display apparatus 100. The memory 270 stores data to be processed in host 200 and data processed in host 200. The memory 270 includes a main storage and an auxiliary storage of host 200. Regardless of kinds of the memory, a predetermined region of the memory 270 can be allocated as the frame memory region 275. The allocated frame memory region 275 is used like a frame memory of display apparatus 100. The frame memory region 275 stores the image data IMG_COD coded by the timing control unit 150 of display apparatus 100.

Display apparatus 100 includes a liquid crystal panel 110, a gate driving unit 120, a level shifter 140, a timing control unit 150, and a power supply 170. All the function blocks of display apparatus 100 are formed on the same glass substrate. Liquid crystal panel 110 includes a top substrate with a common electrode, and a bottom substrate with a pixel electrode P. Liquid crystals are injected between the top substrate and the bottom substrate. The bottom substrate has a plurality of gate lines G arranged at regular distances. A plurality of data lines D are arranged at regular distances in a direction perpendicular to gate lines G. Thin film transistors (TFTs) T are arranged at intersection regions of gate lines G and the data lines D in a matrix form. The TFTs correspond to respective pixels. In an equivalent circuit of one pixel in liquid crystal panel 110, a liquid crystal capacitance Clc and a storage capacitance Cst are connected in parallel to one TFT T. In addition, a backlight (not shown) providing uniform light source is provided at a rear side of liquid crystal panel 110. A cold cathode fluorescent lamp (CCFL) is widely used as the light source of the backlight.

Timing control unit 150 outputs to-be-displayed data, clock signal and data to gate driving unit 120 and source driving unit 130, at a timing suitable to display the data on a screen, in response to the image signal IMG, horizontal/vertical synchronization signals, and a clock signal. Timing control unit 150 has a coder-decoder (CODEC) 155. CODEC 155 codes the image signal IMG input from host 200, and decodes the coded image signal into an original image signal IMG. The decoded image signal is substantially identical to the image signal IMG input from host 200.

In pipeline fashion, the image signal IMG input from host 200 is encoded by codec 155 as IMG_COD for storage in the frame memory region of memory 270, decoded by codec 155 for display and transmitted to level shifter 140 so that it can be displayed at a frequency (e.g., more than 30 frames per second) suitable to display a moving image. Level shifter 140 receives the decoded image signal IMG_DEC from codec 155 of timing control unit 150, amplifies the voltage level of the decoded image signal IMG_DEC, and outputs the amplified signal to source driving unit 130. Gate driving unit 120 activates gate lines G in sequence by applying gate driving pulses to gate lines G of liquid crystal panel 110 under control of timing control unit 150. Source driving unit 130 generates data voltages corresponding to the output of the level shifter 140 under control of timing control unit 150, and applies the data voltages to data lines D.

Although an internal circuit of source driving unit 130 is somewhat different according to chip makers, source driving unit 130 generally includes a shift register that sequentially shifts the to-be-displayed image signals (that is, the output of the level shifter 140) of the digital data type, a digital-to-analog converter (DAC) that converts the image signals of the digital data type into analog voltage values, and a source driver output circuit that outputs the analog voltage values to the data lines D. When a clock signal corresponding to an instruction to provide the analog voltage values to liquid crystal panel 110 is input from timing control unit 150, the source driver output circuit drives the data lines D and applies the image signals to liquid crystal capacitors Clc through the turned-on TFTs T.

Power supply 170 receives DC power PC_POWER from an external circuit or host 200, and generates a plurality of internal driving voltages required to operate display apparatus 100. The internal driving voltages used in display apparatus 100 include a power supply voltage (Vdd), a gate on voltage (Vgh), a gate off voltage (Vgl), a gamma reference voltage (Vref), and a common voltage (Vcom). Preferably, power supply 170 is configured with a DC/DC converter.

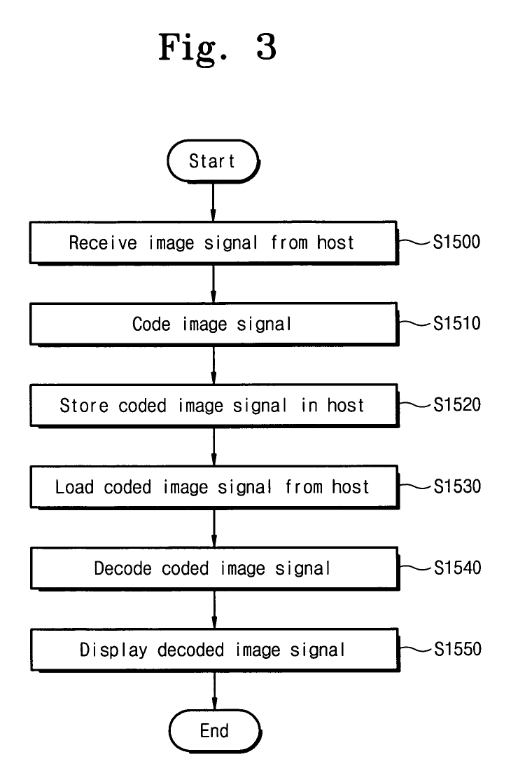

FIG. 3 is a flowchart illustrating a driving method of display apparatus 100 illustrated in FIG. 2.

Referring to FIG. 3, display apparatus 100 receives the image signal IMG from host 200 (step S1500), and codes the received image signal IMG (step S1510). The coding of the received image signal IMG is performed at codec 155 of timing control unit 150. Then, display apparatus 100 stores the coded image signal IMG_COD in the frame memory region 275 of the memory 270 provided in host 200 (step S1520).

The frame memory region 275 of the memory 270, in which the coded image signal IMG_COD is stored, is controlled by display apparatus 100, as if the frame memory region 275 is the frame memory of display apparatus 100. Next, display apparatus 100 loads the coded image signal IMG_COD from the memory 270 of host 200 (step S1530), and decodes the loaded image signal IMG_COD (step S1540). The decoding of the coded image signal IMG_COD is also performed at codec 155 of timing control unit 150. The decoded image signal IMG_DEC is displayed through liquid crystal panel 110 of display apparatus 100 (step S1550).

As described above, according to the SOG technology, liquid crystal panel 110 and the plurality of driving circuits are all formed on the substrate for liquid crystal panel 110, that is, on the same glass substrate. The plurality of driving circuits include gate driving unit 120, source driving unit 130, level shifter 140, timing control unit 150, and power supply 170. Instead of a separate frame memory, display apparatus 100 uses a predetermined region of the memory 270 provided in host 200 by allocating it as the frame memory region 275. The image data stored in the frame memory region 275 has the coded data format. Accordingly, the chip size required for display apparatus 100 is reduced and therefore the entire chip size of the information processing system 300 is reduced. In addition, since the image data transmitted/received between display apparatus 100 and host 200 has the coded format, the amount of transmission data is also reduced.

Although display apparatus 100 implemented using the SOG (or SOP) technology has been described, host 200 can also be implemented on a single substrate by using the SOG technology. In some cases, the entire information processing system 300 can be implemented on a single substrate. Even when both display apparatus 100 and host 200 are implemented on a single substrate by using the SOG technology, the characteristics of the present invention can be all applied. Accordingly, a necessary memory size is reduced and therefore the entire chip size is reduced. In addition, an amount of transmission data is reduced.

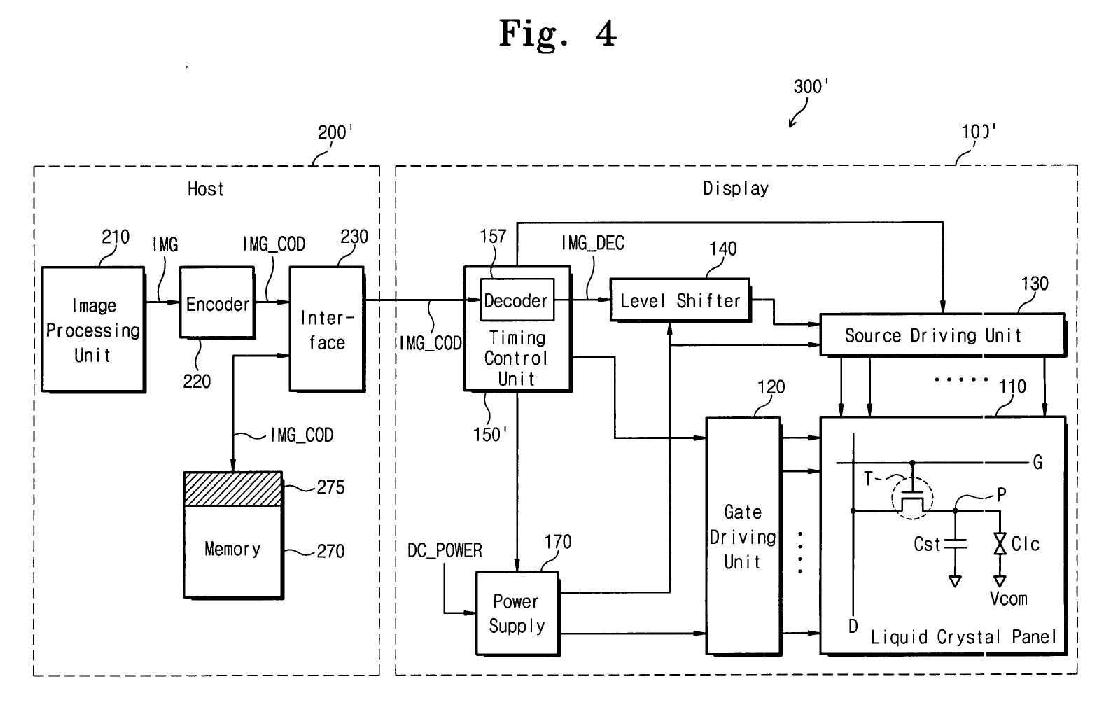

FIG. 4 is a block diagram of an SOG display apparatus 100′ and an information processing system 300′ according to another embodiment of the present invention. The SOG display apparatus 100′ and the information processing system 300′ illustrated in FIG. 4 are similar to the SOG display apparatus 100 and the information processing system 300 illustrated in FIG. 2. A significant difference is the structure of coding the image signal IMG and the structure of decoding the coded image data IMG_COD. The same reference numerals in FIGS. 3 and 4 are used to refer to the same function blocks, and a detailed description thereof will be omitted.

Referring to FIG. 4, host 200′ includes encoder 220 between image processing unit 210 and interface 230 so as to directly provide a coded image signal IMG_COD to display apparatus 100′. Encoder 220 codes image signal IMG received from image processing unit 210. The coded image signal IMG_COD is stored in frame memory region 275 of memory 270 through interface 230. The coded image signal IMG_COD stored in frame memory region 275 is input to decoder 157 of timing control unit 150′ through the interface 230. Encoder 220 may be provided inside image processing unit 210, or may be configured as a separate block, as illustrated in FIG. 4.

Display apparatus 100′ directly loads the coded image signal IMG_COD stored in frame memory region 275 of host 200′, and displays the loaded image signal. For this purpose, display apparatus 100′ includes a decoder 157 inside timing control unit 150′. Decoder 157 decodes the coded image signal IMG_COD transmitted from host 200′, and transmits the decoded image signal IMG_DEC to level shifter 140. Like display apparatus 100 of FIG. 2, display apparatus 100′ of FIG. 4 does not include a separate frame memory, but uses a predetermined region of memory 270 provided in host 200′ by allocating it as frame memory region 275. Accordingly, the entire chip size of display apparatus 100′ and of information processing system 300′ is reduced as well as the amount of transmission data.

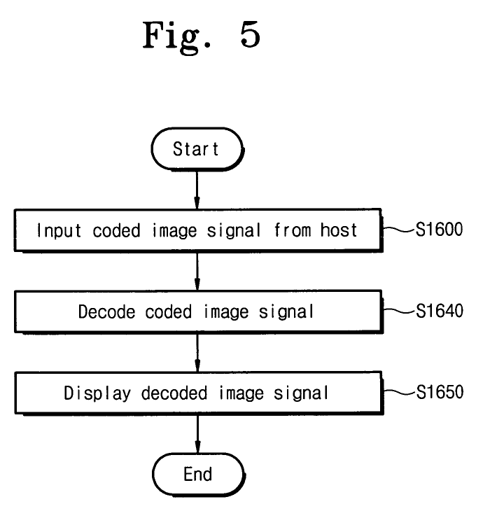

FIG. 5 is a flowchart illustrating the method of driving the display apparatus 100′ illustrated in FIG. 4.

Referring to FIG. 5, display apparatus 100′ receives the coded image signal IMG_COD from host 200′ (step S1600). The coded image signal IMG_COD is generated by encoder 220 of host 200′ The coded image signal IMG_COD is stored in frame memory region 275 of memory 270 provided in host 200′ and is loaded in display apparatus 100′ (step S1600). Frame memory region 275 of memory 270, in which the coded image signal IMG_COD is stored, is controlled by display apparatus 100′, as if the frame memory region 275 was the frame memory of display apparatus 100′.

Next, display apparatus 100′ decodes the coded image signal IMG_COD. The decoding of the coded image signal IMG_COD is performed at decoder 157 provided inside timing control unit 150′. The decoded image signal IMG_DEC is displayed through liquid crystal panel 110 of display apparatus 100′ (step S1650). As described above, display apparatus 100′ is formed on a single glass substrate by using the SOG technology. A separate frame memory is not provided inside display apparatus 100′. Instead, display apparatus 100′ uses the frame memory region 275 allocated to the memory 270 of host 200′. The image data stored in the frame memory region 275 has a coded data format. Accordingly, the entire chip size of display apparatus 100′ is reduced and therefore the entire chip size of the information processing system 300′ is reduced. In addition, since the image data transmitted/received between display apparatus 100′ and host 200′ has a coded format, the amount of transmission data is also reduced.

Although the LCD has been described as an example of display apparatus 100 and 100′, the present invention can also be applied to various kinds of display apparatus using a driving method similar to (or the same as) the LCD, such as plasma display panel (PDP), electro luminescent display (ELD), light emitting diode (LED) display, and vacuum fluorescent display (VFD). In addition, the display apparatus and the associated information processing system according to the present invention are suitable for mobile devices satisfying lightweight, slim and low-power characteristics. Further, the present invention can also be applied to other fixed display apparatuses as well as the mobile devices.

It will be apparent to those skilled in the art that various modifications and variations can be made in the present invention without departing from the spirit and scope thereof.

What is claimed is:

1. An information processing system comprising:
a host generating an image signal and storing a coded image signal provided from an exterior; and
a liquid crystal display apparatus coding the image signal from the host to generate the coded image signal and providing the host with the coded image signal, the liquid crystal display apparatus reading the coded image signal stored in the host and decoding the coded image signal to display an image using the decoded image signal.

2. The information processing system of claim 1, wherein the host includes:
an image processing unit generating the image signal;
an interface transmitting the image signal to the liquid crystal display apparatus and receiving the coded image signal from the liquid crystal display apparatus; and
a memory storing the coded image signal received from the liquid crystal display apparatus, the coded image signal stored in the memory being transmitted to the liquid crystal display apparatus through the interface.

3. The information processing system of claim 2, wherein at least one region among data storage spaces of the memory is allocated as a frame memory region of the liquid crystal display apparatus.

4. The information processing system of claim 2, wherein the liquid crystal display apparatus includes:
a timing control unit coding the image signal and storing the coded image signal in the memory, said timing control unit receiving the coded image signal from the memory and decoding the coded image signal into an image signal;
a driving unit generating a data voltage corresponding to the decoded image signal; and
a liquid crystal panel displaying the image signal in response to the data voltage.

5. The information processing system of claim 4, wherein the timing control unit, the driving unit, and the liquid crystal panel are formed on the same substrate based on one of an SOG (system on glass) technology and an SOP (system on plastic) technology.

6. The information processing system of claim 4, wherein the timing control unit includes a CODEC (coder-decoder) coding the image signal and decoding the coded image signal.

7. The information processing system of claim 4, wherein the driving unit includes:
a level shifter amplifying a voltage level of the decoded image signal;
a gate driving unit activating gate lines of the liquid crystal panel under control of the timing control unit; and
a source driving unit generating the data voltage corresponding to an output of the level shifter under control of the timing control unit and outputting the data voltage to data lines of the liquid crystal panel.

8. An information processing system comprising:
a host generating an image signal to be displayed and coding the generated image signal to store the coded image signal therein, the host having a memory in which the coded image signal is stored; and
a liquid crystal display apparatus reading the stored image signal from the host and decoding the read image signal to display an image using the decoded image signal.

9. The information processing system of claim 8, wherein the host includes:
an image processing unit generating the image signal to be displayed through the liquid crystal display apparatus; and
an encoder coding the image signal.
an interface transmitting the coded image signal stored in the memory to the liquid crystal display apparatus.

10. The information processing system of claim 9, wherein at least one region among data storage spaces of the memory is allocated as a frame memory region of the liquid crystal display apparatus.

11. The information processing system of claim 9, wherein the liquid crystal display apparatus includes:
a timing control unit receiving the coded image signal stored in the memory and decoding the coded image signal;
a driving unit generating a data voltage corresponding to the decoded image signal; and
a liquid crystal panel displaying the image in response to the data voltage.

12. The information processing system of claim 11, wherein the timing control unit, the driving unit, and the liquid crystal panel are formed on the same substrate based on one of an SOG (system on glass) technology and an SOP (system on plastic) technology.

13. The information processing system of claim 11, wherein the timing control unit includes a decoder decoding the coded image signal from the host.

14. The information processing system of claim 11, wherein the driving unit includes:
a level shifter amplifying a voltage level of the decoded image signal;
a gate driving unit activating gate lines of the liquid crystal panel under control of the timing control unit; and
a source driving unit generating the data voltage corresponding to an output of the level shifter under control of the timing control unit and outputting the data voltage to data lines of the liquid crystal panel.

15. A display apparatus comprising:
a host part generating an image signal, the host part having a memory to store a coded image signal and output the coded image signal; and
a liquid crystal display part displaying an image using the coded image signal,
the liquid crystal display part comprising:
a timing control unit coding the image signal input from the host part and storing the coded image signal in the memory, the timing control unit reading the coded image signal stored in the memory and decoding the coded image signal;
a driving unit generating a data voltage corresponding to the decoded image signal; and
a liquid crystal panel displaying the image corresponding to the decoded image signal in response to the data voltage,
wherein the timing control unit, the driving unit and the liquid crystal panel are formed on a same substrate.

16. The display apparatus of claim 15, wherein the timing control unit, the driving unit, and the liquid crystal panel are formed on the same substrate based on one of an SOG (system on glass) technology and an SOP (system on plastic) technology.

17. The display apparatus of claim 15, wherein the timing control unit includes a CODEC (coder-decoder) to code the image signal and decode the coded image signal.

18. The display apparatus of claim 15, wherein at least one region of the memory of the host part is allocated as a frame memory region for the liquid crystal display part.

19. The display apparatus of claim 15, wherein the driving unit includes:
a level shifter amplifying a voltage level of the decoded image signal;
a gate driving unit activating gate lines of the liquid crystal panel under control of the timing control unit; and
a source driving unit generating the data voltage corresponding to an output of the level shifter under control of the timing control unit, and outputting the data voltage to data lines of the liquid crystal panel.

20. A display apparatus comprising:
a host part generating an image signal and coding the image signal, the host part having a memory to store the coded image signal and output the coded image signal; and
a liquid crystal display part displaying an image using the coded image signal,
the liquid crystal display part comprising:
a timing control unit receiving the coded image signal from the memory and decoding the coded image signal into an image signal to be displayed;
a driving unit generating a data voltage corresponding to the decoded image signal; and
a liquid crystal panel displaying an image corresponding to the image signal in response to the data voltage,
wherein the timing control unit, the driving unit and the liquid crystal panel are formed on a same substrate.

21. The display apparatus of claim 20, wherein the timing control unit, the driving unit, and the liquid crystal panel are formed on the same substrate based on one of an SOG (system on glass) technology and an SOP (system on plastic) technology.

22. The display apparatus of claim 20, wherein the timing control unit includes a decoder decoding the coded image signal.

23. The display apparatus of claim 20, wherein at least one region of the memory is allocated as a frame memory region for the liquid crystal display part.

24. The display apparatus of claim 20, wherein the driving unit includes:
a level shifter amplifying a voltage level of the decoded image signal;
a gate driving unit activating gate lines of the liquid crystal panel under control of the timing control unit; and
a source driving unit generating the data voltage corresponding to an output of the level shifter under control of the timing control unit, and outputting the data voltage to data lines of the liquid crystal panel.

25. A driving method of a liquid crystal display apparatus, comprising:
coding a presently input image signal from a host;
storing the coded image signal in a memory included in the host;
loading a previously coded image signal from the memory;
decoding the previously coded image signal loaded from the memory; and
displaying an image corresponding to the decoded image signal.

26. The driving method of claim 25, wherein at least one region of the memory is allocated as a frame memory region of the liquid crystal display apparatus.

27. A driving method of a liquid crystal display apparatus, comprising:
receiving a coded image signal from a memory included in a host;
decoding the coded image signal; and
displaying an image corresponding to the decoded image signal.

28. The driving method of claim 27, wherein at least one region of the memory is allocated as a frame memory region of the liquid crystal display apparatus.
